(19) United States
(12) Patent Application Publication
(10) Pub. No.: US 2021/0017433 A1
(43) Pub. Date: Jan. 21, 2021

(54) CHALK FOR ATHLETIC ACTIVITIES

(71) Applicant: Rock Anthony Tate, JR., West Palm Beach, FL (US)

(72) Inventor: Rock Anthony Tate, JR., West Palm Beach, FL (US)

(21) Appl. No.: 16/927,005

(22) Filed: Jul. 13, 2020

Related U.S. Application Data
(60) Provisional application No. 62/875,048, filed on Jul. 17, 2019.

(51) Int. Cl. C09K 3/14

(52) U.S. Cl. CPC C09K 3/149; A63B 69/0048

(57) ABSTRACT

An athletic chalk comprising plaster of Paris, magnesium carbonate and activated charcoal, having relative proportions of materials of approximately 71-75% plaster of Paris, 19-23% magnesium carbonate and 10-2% activated charcoal, and a method for producing same.

### CROSS REFERENCE TO RELATED APPLICATION

The present invention claims the benefit of provisional U.S. application No. 62/875,048, filed Jul. 17, 2019, the entire disclosure of which is hereby incorporated by reference.

### FIELD OF THE INVENTION

The present invention relates to the field of chalk used in athletic activities such as weightlifting, rock climbing and gymnastics.

### BACKGROUND

Chalk is a grip agent commonly used in any sport in which losing one's grip can be a problem, such as in gymnastics, rock climbing and weightlifting. People involved in such activities usually sweat, and during such activities, sweaty hands can be very dangerous. Chalk functions to dry the hands, by absorbing perspiration and oils, to help reduce slippage, and it also can protect the hands against skin tears.

Prior art chalks are typically in powdered form. Such powdered prior art chalks are known to produce airborne “clouds” of chalk powder, which have been reported to contain traces of Staphylococcus, Salmonella, E. coli, and perhaps other pathogens. Of course, such pathogens may be hazardous if inhaled, or if they become embedded in the surface of the skin. Additionally, prior art chalks, which typically are white in color, leave unsightly chalk marks on dark-colored mats.

### SUMMARY OF THE INVENTION

The present invention avoids the foregoing difficulties of prior art chalks. In accordance with a first aspect of the present invention, an athletic chalk comprises plaster of Paris, magnesium carbonate and activated charcoal. The athletic chalk may have relative proportions of materials of approximately 71-75% plaster of Paris, 19-23% magnesium carbonate and 10-2% activated charcoal. It may be made by mixing the plaster of Paris with water in a first step, adding, in a second step, the magnesium carbonate and activated charcoal to the plaster of Paris and water produced in the first step, stirring, in a third step, the results of the first and second steps, pouring, in a fourth step, the results of the third step into a mold or container, and drying the results of the fourth step. Preferably, the water used in the first step is less than approximately 60 degrees F. In accordance with specific embodiments, the relative proportions of materials can be approximately 71% plaster of Paris, 19% magnesium carbonate, and 10% activated charcoal, or alternatively, approximately 75% plaster of Paris, 23% magnesium carbonate, and 2% activated charcoal.

In accordance with a second aspect of the invention, a method for producing athletic chalk comprises combining water, plaster of Paris, magnesium carbonate and activated charcoal to form a mixture, pouring the mixture into a more mold or container, and allowing the poured mixture to dry. The relative proportions of materials may be approximately 71-75% plaster of Paris, 19-23% magnesium carbonate, and 10-2% activated charcoal. The method may further comprise mixing the plaster of Paris with water in a first step, adding, in a second step, the magnesium carbonate and activated charcoal to the plaster of Paris and water produced in the first step, stirring, in a third step, the results of the first and second steps, pouring, in a fourth step, the results of the third step into a mold or container, and drying the results of the fourth step. Preferably, the water used in the first step is less than approximately 60 degrees F. In accordance with specific embodiments, the relative proportions of materials may be approximately 71% plaster of Paris, 19% magnesium carbonate, and 10% activated charcoal, or alternatively approximately 75% plaster of Paris, 23% magnesium carbonate, and 2% activated charcoal.

Because the chalk produced in accordance with the present invention is in solid form, the present invention decreases the threat posed by airborne “clouds” of chalk powder. Moreover, through the addition of activated charcoal, the present invention provides antibacterial and other benefits such as the removal of micro-particles, such as dirt, dust, chemicals, toxins and bacteria, from the surface of the skin, and can facilitate skin exfoliation during use. Finally, the present invention will not leave unsightly chalk marks on dark-colored mats.

### DETAILED DESCRIPTION OF THE INVENTION

The present invention is an improved formulation of weightlifting chalk which improves athletic performance, is more hygienic, has antimicrobial qualities, and will not leave unsightly residue on dark colored exercise mats. As used herein, the term “athletic chalk” refers to a chalk product that can be used in any athletic activity in which losing one's grip can be a problem, such as, for example, weightlifting, rock climbing and gymnastics.

The athletic chalk in accordance with the present invention is prepared according to the following recipes, using the following proportions and quantities, which, as will be appreciated, may be increased to produce larger quantities of product, as desired. All of the following measurements are approximate, with minor variations in weights, volumes and times being acceptable and within the scope of the present invention:

### EXAMPLE 1

Step 1: 450 grams of plaster of Paris (known naturally as gypsum) is thoroughly mixed with 3 cups of cool water, which is preferably at less than 60 degrees F.

Step 2: 120 grams of powdered magnesium carbonate and 60 grams of powdered activated charcoal are slowly folded together into the mixture produced in Step 1.

Step 3: Over approximately 8 minutes, the mixture produced in Step 2 is stirred to the correct consistency, which is malleable when newly mixed, similar to loose cement. In this state, the mixture is able to stick to stirring equipment, but easily transferable to molds or apparatuses of any kind. The 8-minute period is important to ensure that the materials are not mixed too quickly. Otherwise, the contents the mixture will bulk up and will not be the consistency of loose cement.

Step 4: The mixture produced in Step 3 is poured into a casting mold (to produce a solid “briquette”), or a tube or container from which the product can be dispensed (much like a stick of deodorant). As an example, each tube/container may contain 65 grams of the product. Preferably, this step is completed within 30 minutes or less after the completion of Step 3 to assure ease of transferring to the mold, or the tube/container. Otherwise, the product will harden and may not be transferable.

Step 5: The mixture sets in the mold or tube/container for 12-16 hours, after which the product should be removed from the mold, or temporarily raised out of the tube/container, to dry completely, preferably for another 12-16 hours, for optimal use.

The final product made from the foregoing steps has the following approximate proportions: plaster of Paris: 71%, magnesium carbonate: 19%, and activated charcoal: 10%. It has a dark appearance due to the relative proportion of activated charcoal.

A lighter color product can be made from the following recipe using the following proportions and quantities, which, as will be appreciated, may be increased to produce larger quantities of product, as desired. Again, all measurements are approximate, with minor variations in weights, volumes and times being acceptable and within the scope of the present invention:

### EXAMPLE 2

Step 1: 450 grams of plaster of Paris (known naturally as gypsum) is thoroughly mixed with 3 cups of cool water which is preferably at less than 60 degrees F.

Step 2: 140 grams of powdered magnesium carbonate and 15 grams of powdered activated charcoal are slowly folded together into the mixture produced in Step 1.

Step 3: Over approximately 8 minutes, the mixture produced in Step 2 is stirred to the correct consistency, which is malleable when newly mixed, similar to loose cement. In this state, the mixture is able to stick to stirring equipment, but easily transferable to molds or apparatuses of any kind. The 8-minute period is important to ensure that the materials are not mixed too quickly. Otherwise, the contents the mixture will bulk up and will not be the consistency of loose cement.

Step 4: The mixture produced in Step 3 is poured into a casting mold (to produce a solid “briquette”), or a tube or container from which the product can be dispensed (much like a stick of deodorant). As an example, each tube/container may contain 65 grams of the product. Preferably, this step is completed within 30 minutes or less after the completion of Step 3 to assure ease of transferring to the mold, or the tube/container. Otherwise, the product will harden and may not be transferable.

Step 5: The mixture sets in the mold or tube/container for 12-16 hours, after which the product should be removed from the mold, or temporarily raised out of the tube/container, to dry completely, preferably for another 12-16 hours, for optimal use.

The final product made from the steps of Example 2 has the following approximate proportions: plaster of Paris: 75%, magnesium carbonate: 23%, and activated charcoal: 2%. It has a lighter appearance than that of Example 1 due to the lower proportion of activated charcoal.

Additionally, it will be appreciated that the proportions may range from those of Examples 1 and 2, so that the relative proportions of materials can be approximately 71 to 75% plaster of Paris; 19 to 23% magnesium carbonate; and 10 to 2% activated charcoal.

The product produced using the foregoing recipes provides superior performance characteristics compared to prior art chalks. For example, the product made in accordance with the present invention forms as a dense, solid brick or dispensable material for easy, targeted application to the hands as desired. This is in contrast to the loose, powdered prior art chalks which, in use, are known to produce airborne “clouds” of chalk powder, which have been reported to contain traces of Staphylococcus, Salmonella, E. coli, and perhaps other pathogens that may be hazardous if inhaled. By keeping the chalk out of the air, the present invention decreases this threat.

Moreover, through the addition of activated charcoal, the present invention provides antibacterial and other benefits. Specifically, the activated charcoal facilitates the removal of micro-particles, such as dirt, dust, chemicals, toxins and bacteria from the surface of the skin, and can facilitate skin exfoliation during use.

Finally, the present invention will not leave unsightly chalk marks on dark-colored mats.

It will be appreciated that minor variations in the above quantities, proportions and times may be used without departing from the scope and spirit of the invention, as defined by the following claims.

I claim:

1. Athletic chalk comprising:
a. plaster of Paris;
b. magnesium carbonate; and
c. activated charcoal.

2. The athletic chalk of claim 1 wherein the relative proportions of materials are approximately 71 to 75% plaster of Paris; 19 to 23% magnesium carbonate; and 10 to 2% activated charcoal.

3. The athletic chalk of claim 1 wherein said chalk is made by
a. mixing said plaster of Paris with water in a first step;
b. adding, in a second step, said magnesium carbonate and activated charcoal to said plaster of Paris and water produced in said first step;
c. stirring, in a third step, the results of said first and second steps;
d. pouring, in a fourth step, the results of the third step into a mold or container; and
e. drying the results of the fourth step.

4. The athletic chalk of claim 3 wherein said water used in said first step is less than approximately 60 degrees F.

5. The athletic chalk of claim 1 wherein the relative proportions of materials are approximately 71% plaster of Paris; 19% magnesium carbonate; and 10% activated charcoal.

6. The athletic chalk of claim 1 wherein the relative proportions of materials are approximately 75% plaster of Paris; 23% magnesium carbonate; and 2% activated charcoal.

7. A method for producing athletic chalk comprising:
a. combining water, plaster of Paris, magnesium carbonate and activated charcoal to form a mixture;
b. pouring said mixture into a more mold or container; and
c. allowing said poured mixture to dry.

8. The method of claim 7 wherein the relative proportions of materials are approximately 71-75% plaster of Paris; 19-23% magnesium carbonate; and 10-2% activated charcoal.

9. The method of claim 7 further comprising:
a. mixing said plaster of Paris with water in a first step;
b. adding, in a second step, said magnesium carbonate and activated charcoal to said plaster of Paris and water produced in said first step;
c. stirring, in a third step, the results of said first and second steps;
d. pouring, in a fourth step, the results of the third step into a mold or container; and
e. drying the results of the fourth step.

10. The method of claim 9 wherein said water used in said first step is less than approximately 60 degrees F.

11. The method of claim 7 wherein the relative proportions of materials are approximately 71% plaster of Paris; 19% magnesium carbonate; and 10% activated charcoal.

12. The method of claim 7 wherein the relative proportions of materials are approximately 75% plaster of Paris; 23% magnesium carbonate; and 2% activated charcoal.
